(19) United States
(12) Patent Application Publication
(10) Pub. No.: US 2010/0028546 A1
(43) Pub. Date: Feb. 4, 2010

(54) USE OF POLYMER DISPERSIONS IN COATING MATERIALS

(75) Inventors: Konrad Roschmann, Ludwigshafen-Edigheim (DE); Gerhard Fischer, Dirmstein (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/440,023

(22) PCT Filed: Sep. 18, 2007
(86) PCT No.: PCT/EP07/59817

§ 371 Date: Mar. 5, 2009

(30) Foreign Application Priority Data
Sep. 20, 2006 (EP) 06120935.9

(51) Int. Cl. B05D 3/00; C09D 1/00; C09D 133/10; C09D 133/18; C09D 125/04

(52) U.S. Cl. 427/385.5; 524/560; 524/565; 524/543; 524/577

(57) ABSTRACT

The present invention relates to the use in coating compositions of polymer dispersions comprising polymer particles having differently crosslinked regions intraparticulately.

The present invention relates to the use in coating compositions of polymer dispersions comprising polymer particles having differently crosslinked regions intraparticulately.

DE 10 2004 047526 A1 describes polymer dispersions featuring improved early water-spot resistance which comprise a phosphate-functional emulsifier and a monophase crosslinked polymer.

Core-shell polymers are diversely known, from EP 710680, WO 03/99949 or EP 736573, for example.

D. I. Lee in Polymer, 46 (2005) 1287-1293 describes the influence of crosslinking in polymer dispersions on wet tensile strength. A polymer is disclosed comprising a core of butyl acrylate, styrene, acrylic acid, and divinylbenzene and a shell of butyl acrylate, styrene, and isopropenyloxazolidinone. This system, however, requires polymerization conditions including a pH of 8-9, and is therefore limited only to particular preparation conditions. No influence on early water-spot resistance is described.

It was an object of the present invention to provide coating compositions which exhibit improved early water-spot resistance.

The early water-spot resistance describes the resistance to water of a coating material in a state in which it has not yet undergone full curing through its volume (in the time 1 to 3 hours after application at 20° C. and 60% relative humidity).

The object has been achieved through the use in coating compositions of polymer dispersions comprising polymer particles whose crosslinking density decreases from inside to outside.

The crosslinking of the polymers is possible through formation of covalent bonds and/or noncovalent bonds, such as coordinative, ionic, physical or salt-like bonds, for example. Crosslinking may take place directly when the macromolecules are synthesized by free-radical polymerization, at least some of the monomers used having two or more polymerizable functionalities (crosslinking copolymerization). Alternatively, crosslinking can be produced, albeit less preferably, by reactions on ready-formed (pre)polymers, generally comprising functional groups. These (pre)polymers may be self-crosslinkers, i.e., compounds which, given a choice of suitable conditions, react with one another, or else are crosslinkingly reacted using additional difunctional and polyfunctional (low molecular mass) reagents (crosslinkers).

Preferably at least one crosslinker is added as early as during the polymerization.

The crosslinking density is determined for the purposes of this specification, theoretically, along the shortest connecting line running from the center of mass of the polymer particle in question to its surface.

The inside region, which in accordance with the invention has a heightened crosslinking density, is composed of a spherical region around the center of mass of the polymer particle that makes up 20% of the total volume of the polymer particle. In the case of an ideal sphere, in other words, this would be about 0.58 of the total radius.

The outer region, which in accordance with the invention has a crosslinking density reduced relative to that of the inside region, is composed of a shell which reaches inward from the outside face of the polymer particle and which makes up 20% of the total volume of the polymer particle. In the ideal case of an ideal sphere, in other words, this would be a spherical shell comprising the region from 0.93 of the total radius to the outside face.

The crosslinking density from the inside region to the outer region may decrease in any desired way (see below).

The polymers from which the polymer particles may have been constructed are polymers which are synthesized essentially from ethylenically unsaturated compounds, preferably from compounds comprising one or more C═C double bonds (monomers).

Such monomers are generally polymerized anionically, cationically or free-radically, preferably free-radically.

The feature which is critical in accordance with the invention is that of the crosslinking density decreasing from inside to outside in the polymer particles. It can frequently, if not always, be measured by measuring the glass transition temperatures of inside region and outer region.

However, if for example there are relatively small differences in the crosslinking density or if there is a gradual change in the crosslinking density in the course of the radius of the polymer particle, the difference in the glass transition temperatures of inside region and outer region may be too small or indefinite for measurement in practice.

In one preferred embodiment, inside region and outer region differ at least in their measured glass transition temperature. A calculation of the glass transition temperature by known methods based on tabulated values for specific monomers, such as in accordance with Fox, for example, does not necessarily lead to different glass transition temperatures of the regions if, for example, crosslinkers are used as monomers and their influence on the glass transition temperature cannot be gaged arithmetically.

In this specification the glass transition temperature, T_{g}, is preferably determined in accordance with ASTM standard D3418-03 via differential scanning calorimetry (DSC), preferably with a heating rate of 10° C./min.

The difference in the glass transition temperatures, ΔT_{g}, between inside region and outer region is preferably up to 20° C., more preferably up to 15° C., very preferably up to 10° C., and in particular up to 5° C. The inside region has a higher glass transition temperature than the outer region.

The glass transition temperature T_{g} of the phase having the lower T_{g}, i.e., the soft phase, is for example at least 0° C., preferably at least 10° C., more preferably at least 15° C., very preferably at least 20° C., and in particular at least 25° C.

The glass transition temperature T_{g} of the phase having the higher T_{g}, i.e., the hard phase, is for example up to 70° C., preferably up to 60° C., more preferably up to 50° C., very preferably up to 40° C., and in particular up to 35° C.

In cases where the crosslinking density of inside region and outer region of the polymer particles cannot be determined by a measurement of the glass transition temperature, the preparation process determines the two-stage construction of the invention: for this purpose the incorporation of crosslinking monomer is varied in the preparation process in the course of the polymerization. Methods of achieving this are known to the skilled worker.

This is preferably accomplished by polymerizing at least two compositions of monomers differing in the amount of crosslinking monomer therein: for example, containing an amount of crosslinking monomer that increases in the course of the polymerization, containing an amount of crosslinking monomer which decreases in the course of the polymerization, or containing an amount of crosslinking monomer that increases in the course of the polymerization or containing an amount of regulator that changes in the course of the polymerization (see below). As illustrated by means of the examples of the invention, the monomer compositions are frequently, though not always, polymerized in the order in which they are combined. The sequence of the synthesis of the polymer phases, however, may also take place inversely to the sequence of addition of the monomer compositions. The actual synthesis of the polymer phases is dependent on the mechanism of particle growth, i.e., whether the polymerization takes place via volume growth or via surface growth.

In the preparation process it is frequently possible to control the polymerization by the rate of the feeds of the monomer mixtures to the reaction: the slower the rate at which a monomer mixture is added to a polymerization, the more probable it is that the polymerization will proceed via a surface growth mechanism. Where the monomer mixtures are added to a polymerization at a higher rate, a polymerization via a volume growth mechanism is more likely. By means of simple testing experiments, it is possible for a skilled worker to distinguish between these two possible mechanisms and so to determine the mechanism which actually operates for a defined monomer composition.

The average diameter of the polymer particles in the dispersion (determined in accordance with ISO 13321 using a High Performance Particle Sizer from Malvern at 22° C. and a wavelength of 633 nm) is generally at least 50 nm, preferably at least 70 nm, more preferably at least 80 nm, and very preferably at least 100 nm. The average diameter can in general be up to 500 nm, preferably up to 400 nm, more preferably up to 350 nm, very preferably up to 300 nm, in particular up to 250 nm, and especially up to 200 nm.

In one preferred embodiment of the present invention the low-crosslinker phase, which comprises the outer region, occupies on average the outer 10 to 40 nm of the total diameter, more preferably the outer 15 to 30 nm, and very preferably, roughly, the outer 20 nm of the total diameter of the polymer particles.

Inner, more highly crosslinked phase and outer, low-crosslinker phase ought in general to be present in a volume ratio of 10:90-80:20, preferably of 10:90-70:30, more preferably of 15:85-60:40, very preferably of 20:80-55:45, and in particular of 30:70 to 50:50.

In one preferred embodiment of the present invention the polymer particles are core-shell polymer particles.

In accordance with the invention the polymer particles are composed of at least one core, 1 to 3 for example, preferably 1 to 2, more preferably precisely one core, and of at least one shell, 1 to 3 for example, preferably 1 to 2, more preferably precisely one shell.

Where the polymer particles are prepared by polymerization on a seed, the number of polymer phases in the polymer particle is increased by the phase which originally formed the seed.

Ideally, the outermost shell envelops the underlying core completely, although for the purposes of the present invention it is sufficient if the outermost shell covers the surface of the underlying core predominantly, i.e., to an extent of at least 60%, preferably at least 70%, more preferably at least 80%, very preferably at least 90%, and in particular at least 95%.

In one possible embodiment it is possible for different degrees of crosslinking of the inside and outside region to be produced by leaving the concentration of monomers and crosslinkers in the reaction mixture largely constant but varying the amount of regulator (chain transfer agent).

As a result of the presence of regulators in a polymerization, chain termination and the start of a new chain by the new free radical thus formed have the general effect of reducing the molecular weight of the resulting polymer and, if crosslinkers are present, of reducing the number of crosslinking sites (crosslinking density) as well. If the concentration of regulator is increased in the course of a polymerization, then in the course of the polymerization the crosslinking density is further decreased.

Molecular weight regulators of this kind are known, and may for example be mercapto compounds, such as tertiary dodecyl mercaptan, dimeric α-methylstyrene, 2-ethylhexyl thioglycolate (EHTG), 3-mercaptopropyltrimethoxysilane (MTMO) or terpinolene. The molecular weight regulators are known and are described for example in Houben-Weyl, Methoden der organischen Chemie, vol. XIV/1, p. 297 ff., 1961, Stuttgart.

The difference in the degrees of crosslinking of the inside region and outside region can be achieved with preference by means of a different composition of the polymers in inside region and outer region in terms of crosslinkers. Crosslinkers for the purposes of this specification are monomers having at least two C═C double bonds which are able to react under the chosen polymerization conditions.

The use of crosslinkers leads to crosslinking of the polymer phase in which the crosslinkers are copolymerized.

In one preferred embodiment of the present invention the polymer phase forming the outermost shell contains a smaller proportion of crosslinkers in copolymerized form than the polymer phase situated beneath it on the inside. With particular preference the proportion of crosslinkers in copolymerized form in the polymer phases decreases in a gradient from inside to outside.

The gradient may for example be linear or nonlinear, exponential for example, in one or more steps, decreasing from inside to outside, preferably in steps.

Each individual polymer phase of the polymer particles may be synthesized from

a) 60% to 99.99%, preferably 75% to 99.95%, more preferably 85% to 99.8% by weight of at least one principal monomer,
b) 0% to 40%, preferably 0% to 25%, more preferably 0% to 15% by weight of at least one further, copolymerizable monomer, and
c) 0.01% to 3%, preferably 0.05% to 1%, more preferably at least 0.2% to 0.25% by weight of at least one crosslinker,
with the proviso that the sum always amounts to 100% by weight.

Principal monomers a) comprise precisely one free-radically polymerizable group and preferably no other functional groups, and are selected from the group consisting of C₁-C₂₀ alkyl(meth)acrylates, vinyl esters of carboxylic acids comprising up to 20 C atoms, vinylaromatics having up to 20 C atoms, ethylenically unsaturated nitriles having up to 20 C atoms, vinyl halides having up to 10 C atoms, vinyl ethers of alcohols comprising 1 to 10 C atoms, aliphatic hydrocarbons having 2 to 8 C atoms, or mixtures of these monomers.

Examples of (meth)acrylic acid alkyl esters are methyl(meth)acrylate, ethyl (meth)acrylate, n-propyl(meth)acrylate, n-butyl(meth)acrylate, isobutyl(meth)acrylate, sec-butyl(meth)acrylate, n-pentyl(meth)acrylate, isopentyl(meth)acrylate, 2-methylbutyl(meth)acrylate, amyl(meth)acrylate, n-hexyl(meth)acrylate, 2-ethylbutyl (meth)acrylate, pentyl(meth)acrylate, n-heptyl(meth)acrylate, n-octyl(meth)acrylate, 2-ethylhexyl(meth)acrylate, 2-propylheptyl(meth)acrylate, n-decyl(meth)acrylate, undecyl(meth)acrylate, and n-dodecyl(meth)acrylate.

Preference is given to (meth)acrylic acid alkyl esters with a C₁-C₁₀ alkyl radical, more preferably methyl methacrylate, methyl acrylate, n-butyl acrylate, n-hexyl acrylate, n-octyl acrylate, ethyl acrylate, and 2-ethylhexyl acrylate.

Also suitable in particular are mixtures of the (meth)acrylic acid alkyl esters.

Vinyl esters of carboxylic acids having 1 to 20 C atoms are for example vinyl laurate, vinyl stearate, vinyl propionate, Versatic acid vinyl esters, vinyl butyrate and vinyl acetate.

Suitable vinylaromatic compounds include vinyltoluene, vinylnaphthalene, α- and p-methylstyrene, α-butylstyrene, 4-n-butylstyrene, 4-n-decylstyrene, and, preferably, styrene.

Examples of ethylenically unsaturated nitriles are fumaronitrile, acrylonitrile, and methacrylonitrile.

The vinyl halides are ethylenically unsaturated compounds substituted by chlorine, fluorine or bromine, preferably vinyl chloride and vinylidene chloride.

Examples of vinyl ethers include methyl vinyl ether, ethyl vinyl ether, n-propyl vinyl ether, isopropyl vinyl ether, n-butyl vinyl ether, sec-butyl vinyl ether, isobutyl vinyl ether, tert-butyl vinyl ether and n-octyl vinyl ether. Preference is given to vinyl ethers of alcohols comprising 1 to 4 C atoms.

Aliphatic hydrocarbons having 2 to 8 C atoms include by way of example ethylene, propylene, 1-butene, 2-butene, isobutene, 1-hexene, 1-octene, cyclopentene, cyclohexene, cyclododecene, butadiene, isoprene and chloroprene.

Suitable monomers (a) include preferably the alkyl(meth)acrylates, preferably (C₂ to C₁₀ alkyl)acrylates and methacrylates, and the vinylaromatics, and also mixtures of these compounds.

Very particular preference is given to monomers (a) selected from the group consisting of methyl methacrylate, n-butyl acrylate, n-hexyl acrylate, octyl acrylate, 2-ethylhexyl acrylate, and styrene, and mixtures of these monomers.

Further, copolymerizable monomers b) are monomers which have precisely one free-radically polymerizable group and are different from those specified under (a), preferably those which in addition to the free-radically polymerizable double bond contain at least one, preferably 1 to 3, more preferably 1 to 2, and very preferably precisely one further functional group selected from the group consisting of hydroxyl groups, primary, secondary, tertiary, and quaternary amino groups, carboxamide groups and carboxyl groups, and also sulfate, sulfonate, phosphate, phosphonate or aldehyde-reactive groups, and less preferably epoxy, isocyanate, hydroxymethyl, methoxymethyl or silyloxy groups.

Monomers (b) are, in particular, (meth)acrylates with other than C₁-C₂₀ alkyl groups, examples being alkoxyalkyl, cycloalkyl or C₁-C₁₀ hydroxyalkyl(meth)acrylates, (meth)acrylamide, ethylenically unsaturated acids or acid anhydrides, especially carboxylic acids, such as (meth)acrylic acid, crotonic acid or dicarboxylic acids, such as itaconic acid, maleic acid or fumaric acid.

(Meth)acrylic acid in this description stands for methacrylic acid and acrylic acid.

Alkoxyalkyl(meth)acrylates are, for example, 2-methoxyethyl(meth)acrylate, 2-ethoxyethyl(meth)acrylate, 4-methoxybutyl(meth)acrylate, and 2-(2′-methoxyethoxy)ethyl(meth)acrylate.

Examples of monomers (b) containing carboxyl groups are acrylic acid, methacrylic acid, fumaric acid, monoisopropyl fumarate, mono-n-hexyl fumarate, fumaramide, fumaronitrile, crotonic acid, itaconic acid, itaconic monoesters, itaconic anhydride, citraconic acid, citraconic monoesters, citraconic anhydride, succinic acid, maleic acid, monomethyl maleate, monoethyl maleate, monobutyl maleate, maleic anhydride, dimethylacrylic acid, ethacrylic acid, methylenemalonic acid, mesaconic acid, allylacetic acid, and vinylacetic acid.

Hydroxyalkyl(meth)acrylates are, for example, (meth)acrylic acid formal, hydroxymethyl(meth)acrylate, 2-hydroxyethyl(meth)acrylate, 2-hydroxypropyl (meth)acrylate, 3-hydroxypropyl(meth)acrylate, and 4-hydroxybutyl(meth)acrylate; further possibilities are 4-hydroxybutyl vinyl ether and N-methylolmaleamide.

Further examples of monomers (b) containing groups of different functionality are benzophenoneglycidyl(meth)acrylate, glycidyl(meth)acrylate, glycidyl crotonate, 2-sulfoethyl(meth)acrylate, sodium vinylsulfonate, (meth)acrylamide, fumaramide, monomaleamide, maleamide, N-methylol(meth)acrylamide, ureido(meth)acrylate, vinylsuccinimide, vinylimidazole, 2-vinylpyridine, 4-vinylpyridine, N-vinylpyrrolidone, N-vinylpiperidone, N-vinylcaprolactam,

tetraallyloxyethane, diallylphthalate, diallylsuccinate, tetraallylethane, tetraallyloxysilane, allyl glycidyl ether, triallyl cyanurate, triallyl isocyanurate, diketene, methyl vinyl ketone,
2′-(acetylacetoxy)ethyl methacrylate, and 2′-(2″-oxoimidazolidin-1″-yl)ethyl methacrylate (ureidoethyl methacrylate).

Preferred auxiliary monomers are methacrylic acid, acrylic acid, acrylamide, 2-hydroxyethyl(meth)acrylate, 2-hydroxypropyl(meth)acrylate, 3-hydroxypropyl (meth)acrylate, 4-hydroxybutyl(meth)acrylate, 4-hydroxybutyl vinyl ether, methacrylamide, itaconic acid, 2′-(acetylacetoxy)ethyl methacrylate, 2′-(2″-oxoimidazolidin-1″-yl)ethyl methacrylate (ureidoethyl methacrylate), particular preference being given to acrylic acid, itaconic acid, acrylamide, methacrylamide, 2′-(acetylacetoxy)ethyl methacrylate, and 2′-(2″-oxoimidazolidin-1″-yl)ethyl methacrylate.

Crosslinkers c) are those which contain at least two free-radically polymerizable double bonds, preferably 2 to 6, more preferably 2 to 4, very preferably 2 to 3, and in particular precisely 2.

The free-radically polymerizable double bonds are preferably selected from the group consisting of acrylate, methacrylate, allyl ether and allyl ester.

The free-radically polymerizable groups in the crosslinkers may be alike or different, and are preferably alike.

Preferred allyl ether groups are prop-2-en-1-yloxy, 2-methylprop-2-en-1-yloxy, and but-2-en-1-yloxy, with prop-2-en-1-yloxy being particularly preferred.

Preferred allyl ester groups are prop-2-en-1-yloxycarbonyl, 2-methylprop-2-en-1-yloxycarbonyl, and but-2-en-1-yloxycarbonyl, with prop-2-en-1-yloxycarbonyl being particularly preferred.

Preferred acrylic groups are acryloyloxy and methacryloyloxy.

In the crosslinkers c) the free-radically polymerizable groups are either joined directly to one another or, preferably, joined to one another by an organic radical.

This organic radical has in general 1 to 20 carbon atoms and may besides carbon and hydrogen also comprise further heteroatoms, preferably oxygen, nitrogen or sulfur, more preferably oxygen or nitrogen, and very preferably oxygen.

Preferred crosslinkers containing allyl ether groups are the polyallyl ethers of trimethylolbutane, trimethylolpropane, trimethylolethane, neopentyl glycol, neopentyl glycol hydroxypivalate, pentaerythritol, 2-ethyl-1,3-propanediol, 2-methyl-1,3-propanediol, 2-ethyl-1,3-hexanediol, 2,4-diethyloctane-1,3-diol, glycerol, ditrimethylolpropane, dipentaerythritol, hydroquinone, bisphenol A, bisphenol F, bisphenol B, bisphenol S, 2,2-bis(4-hydroxycyclohexyl)propane, 1,1-, 1,2-, 1,3-, and 1,4-cyclohexanedimethanol, 1,2-, 1,3- or 1,4-cyclohexanediol, ethylene glycol, diethylene glycol, triethylene glycol, higher polyethylene glycols with a molar mass up to 2000, propylene glycol, dipropylene glycol, tripropylene glycol, higher polypropylene glycols with a molar mass up to 2000, 1,3-propanediol, 1,6-hexanediol, 1,4-butanediol, polyTHF having a molar mass up to 2000, sorbitol, mannitol, diglycerol, threitol, erythritol, adonitol (ribitol), arabitol (lyxitol), xylitol, dulcitol (galactitol), maltitol, isomalt, melamine, and also esters of allyl alcohol with polycarboxylic acids, such as phthalic acid, terephthalic acid, isophthalic acid, succinic acid or adipic acid, for example.

Particularly preferred crosslinkers containing allyl ether groups are trimethylolpropane triallyl ether, trimethylolpropane diallyl ether, glycerol triallyl ether, glycerol diallyl ether, ethylene glycol diallyl ether, 1,4-butanediol diallyl ether, 1,6-hexanediol diallyl ether, and diallyl phthalate.

Preferred crosslinkers containing allyl ether and (meth)acrylate groups are allyl acrylate, allyl methacrylate, methallyl acrylate, methallyl methacrylate, but-3-en-2-yl (meth)acrylate, but-2-en-1-yl(meth)acrylate, 3-methylbut-2-en-1-yl(meth)acrylate, esters of (meth)acrylic acid with geraniol, citronellol, cinnamyl alcohol, glycerol mono- or diallyl ether, trimethylolpropane mono- or diallyl ether, ethylene glycol monoallyl ether, diethylene glycol monoallyl ether, propylene glycol monoallyl ether, dipropylene glycol monoallyl ether, 1,3-propanediol monoallyl ether, 1,4-butanediol monoallyl ether, and, furthermore, diallyl itaconate. Of further preference are 5-oxahept-6-en-1-yl (meth)acrylate, 3,4-dihydro-2H-pyran-2-ylmethyl(meth)acrylate, and 2-hydroxybut-3-en-1-yl(meth)acrylate.

Particular preference is given to allyl acrylate and allyl methacrylate, very particular preference to allyl methacrylate.

Examples that may be given of di- and poly(meth)acrylates are 1,2-, 1,3-, and 1,4-butanediol diacrylate, 1,2- and 1,3-propylene glycol (meth)acrylate, 1,6-hexanediol di(meth)acrylate, 1,2-ethylene glycol di(meth)acrylate, neopentyl glycol di(meth)acrylate, diethylene glycol di(meth)acrylate, triethylene glycol di(meth)acrylate, tetraethylene glycol di(meth)acrylate, trimethylolpropane tri(meth)acrylate, trimethylolethane tri(meth)acrylate, pentaerythritol tri- and tetra(meth)acrylate.

Mention may also be made of divinylbenzene and butadiene.

With particular preference the crosslinkers are selected from the group consisting of divinylbenzene, 1,4-butanediol diacrylate, and allyl methacrylate, and butadiene.

Preferred polymers are styrene-butadiene polymers, polyacrylates, styrene-acrylate copolymers, ethylene-acrylate copolymers, and vinyl ester-acrylate copolymers.

The polymer dispersions can be prepared in conventional manner by the methods of emulsion polymerization that are common knowledge, starting from the monomers, using the typical emulsifying and dispersing assistants and polymerization initiators.

Suitable dispersants for implementing free-radically aqueous emulsion polymerizations are protective colloids or emulsifiers that are typically employed, in amounts of 0.1% to 25% by weight, in particular of 0.2% to 10% by weight, based on the monomers.

Further common emulsifiers are, for example, alkali metal salts of higher fatty alcohol sulfates, such as Na n-lauryl sulfate, ethoxylated C₈ to C₁₀ alkylphenols having a degree of ethoxylation of 3 to 30, and ethoxylated C₈ to C₂₅ fatty alcohols having a degree of ethoxylation of 5 to 50. Other suitable emulsifiers are listed in Houben-Weyl, Methoden der organischen Chemie, volume XIV, Makromolekulare Stoffe [Macromolecular compounds], Georg Thieme Verlag, Stuttgart, 1961, pages 192 to 209.

Suitable protective colloids are high molecular mass natural substances such as starch, methylcellulose, pectins and gelatins, synthetic compounds such as polyvinyl alcohol, polyvinylpyrrolidone, and copolymers of acrylic acid, styrene, and other unsaturated compounds. Other protective colloids are described at length in Houben-Weyl, loc. cit., pages 411 to 420.

Suitable polymerization initiators include all those capable of triggering a free-radical emulsion polymerization in aqueous media. They are used generally in amounts of 0.1% to 10%, preferably of 0.2% to 4%, by weight, based on the monomers. Typical compounds are inorganic peroxides, such as sodium and ammonium peroxydisulfate and hydrogen peroxide, organic peroxides such as dibenzoyl peroxide or tert-butyl hydroperoxide, and azo compounds such as azoisobutyronitrile. These initiators are suitable for the reaction temperatures typical in free-radical emulsion polymerizations, namely from 50 to 100° C. Where lower reaction temperatures, of around 40 to 60° C., are required, preference is given to redox systems such as combinations of per compounds and a reductive coinitiator like the sodium salt of hydroxymethanesulfinic acid, ascorbic acid, or iron(II) salts.

The preparation of aqueous polymer dispersions by the free-radical emulsion polymerization method is known per se (cf. Houben-Weyl, Methoden der organischen Chemie, volume XIV, Makromolekulare Stoffe, loc. cit., pages 133 ff.).

One method which has proven particularly appropriate is a feed method, in which the starting point is an initial charge consisting of a portion of the monomers, generally up to 20% by weight, water, emulsifier, and initiator. The remainder of the monomers and any regulators, in emulsified form, and also, additionally, an aqueous solution of further polymerization initiator, are added in line with the polymerization.

In one preferred embodiment of the present invention the polymerization can be carried out as described in EP 853 636 or in U.S. Pat. No. 3,804,881. The disclosure content of these two documents is hereby incorporated by reference.

The aqueous polymer dispersions thus obtained preferably have a solids content of 35% to 65%, more preferably of 45% to 55% by weight.

The polymer dispersions are notable for a high stability, and there is virtually no coagulum formed.

The minimum film-forming temperature (MFT) of the polymer dispersions of the invention is advantageously less than 50° C.

The polymer dispersions can be used as binders for coating materials, such as for varnishes, protective coatings, traffic markings, decorative coatings, paints, coatings on textiles, leather or leather substitutes, for the purpose of improving the early water-spot resistance.

For the different utilities it is possible to add suitable auxiliaries, examples being flow control agents, thickeners, defoamers, fillers, pigments, pigment dispersing assistants, etc.

The coatings can be obtained by applying the coating materials to appropriate substrates, such as wood, concrete, metal, glass, plastic, ceramics, plasters, stone, asphalt, textiles, and coated, primed or weathered substrates.

Application to the substrate may be made in a known way, as for example by spraying, troweling, knifecoating, brushing, rolling, roller coating or pouring. The coating thickness is generally in a range from about 3 to 1000 g/m² and preferably 10 to 200 g/m². The volatile constituents of the dispersions are subsequently removed. This operation may if desired be repeated one or more times.

For removing the water comprised in the dispersion, application to the substrate is followed by drying, in a tunnel oven for example, or by flashing off. Drying may also take place by means of NIR radiation, NIR radiation here denoting electromagnetic radiation in the wavelength range from 760 nm to 2.5 μm, preferably from 900 to 1500 nm. Drying may take place at a temperature from ambient temperature up to 100° C. over a period from a few minutes up to several days.

The coatings obtained generally feature a uniform surface, and in particular a surface free from blisters.

In one particular embodiment, the polymer dispersion of the invention is particularly suitable as a binder for anticorrosion coating materials and as a binder for paints.

Besides the polymer dispersion, the anticorrosion coating materials may further comprise corrosion control agents, such as corrosion inhibitors or active anticorrosion pigments, an example being zinc phosphate.

Even without further corrosion control agents, the polymer dispersion of the invention has a good corrosion control effect in any case.

Using the polymer dispersions, the surfaces of iron, steel, Zn, Zn alloys, Al or Al alloys, as substrates, are treated for corrosion control. The surfaces may be uncoated, may be covered with zinc, aluminum or alloys thereof, may be hot-dip galvanized, electrogalvanized, shearardized or precoated with primers.

Paints, also referred to as emulsion paints, are one of the major product groups in the paints and coatings industry (see Ullmanns Enzyklopädie der technischen Chemie, 4th ed., volume 15, Verlag Chemie, Weinheim 1978, p. 665). Emulsion paints generally comprise a film-forming polymer as binder and as coloring constituent at least one inorganic pigment, and also inorganic fillers and assistants, such as defoamers, thickeners, wetting agents, and, if appropriate, film-forming assistants.

A further important property of the polymer dispersions is the effective blocking resistance of the coatings, by which is meant a minimal degree of sticking of the paint film to itself under pressure load and under elevated temperature (effective blocking resistance).

The paints (emulsion paints) of the invention comprise pigments and fillers preferably in amounts such that the pigment volume concentration (PVC) is 15% to 85% and more preferably 25% to 55%.

Typical pigments are, for example, titanium dioxide, preferably in the rutile form, barium sulfate, zinc oxide, zinc sulfide, basic lead carbonate, antimony trioxide, and lithopones (zinc sulfide+barium sulfate). The emulsion paints may, however, also comprise colored pigments, examples being iron oxides, carbon black, graphite, luminescent pigments, zinc yellow, zinc green, ultramarine, manganese black, antimony black, manganese violet, Paris blue or Schweinfurt green. Besides the inorganic pigments the emulsion paints of the invention may also comprise organic color pigments, examples being sepia, gamboge, Cassel brown, toluidine red, para red, Hansa yellow, indigo, azo dyes, anthraquinonoid and indigoid dyes, and also dioxazine, quinacridone, phthalocyanine, isoindolinone, and metal complex pigments.

Suitable fillers comprise alumosilicates, such as feldspars, silicates, such as kaolin, talc, mica, magnesite, alkaline earth metal carbonates, such as calcium carbonate, in the form for example of calcite or chalk, magnesium carbonate, dolomite, alkaline earth metal sulfates, such as calcium sulfate, silicon dioxide, etc. The fillers can be used as individual components. In actual practice, however, filler mixtures have proven particularly appropriate, examples being calcium carbonate/kaolin and calcium carbonate/talc.

In order to increase the hiding power and to save on the use of white pigments it is common to use finely divided fillers, examples being finely divided calcium carbonate or mixtures of different calcium carbonates with different particle sizes. To adjust the hiding power, the hue, and the depth of color, it is preferred to use blends of color pigments and fillers.

The coatings produced using the emulsion paints of the invention are notable for a high level of early water-spot resistance.

### EXAMPLES

### Description of the Early Water-Spot Resistance Test Method

The coating material under test was diluted to spray viscosity with fully demineralized water and was applied using a compressed-air spray gun to a sandblasted metal panel (of average roughness). The freshly coated panel was left to dry at room temperature for about 2 hours. The dry film thickness ought to be about 90-100 μm. The test panel subsequently entered a container filled with mains water. Here it should be ensured that approximately ¾ of the test panel stands in the water. After 24 hours the panel was removed and immediately rated in accordance with DIN EN ISO 4628 (identification of degree of blistering).

In the degree of blistering, percentages denote the fraction of blistered surfaces as a proportion of the total surface area, and are employed when no uniform blistering was observed. m denotes the amount of the blisters on a scale of 1-5 (few to many). g denotes the size of the blisters on a scale of 1-5 (small to large).

### Comparative Example 1

A preliminary emulsion was prepared from 233 g of water, 89.0 g of a 20% strength aqueous solution of a partly neutralized phosphoric monoester of a fatty alcohol ethoxylate (molar mass about 1100 g/mol), 407.5 g of n-butyl acrylate, 550.0 g of styrene, 25.0 g of acrylic acid, 30.0 g of a 50% strength acrylamide solution, and 2.5 g of 1,4-butanediol diacrylate.

The initial charge, consisting of 300 g of water and 15.0 g of the above partly neutralized phosphoric monoester (in 20% form), in a polymerization vessel which was equipped with an anchor stirrer, reflux condenser, and two feed vessels, was heated under nitrogen to a temperature of 90° C. and, following addition of 66.8 g of the preliminary emulsion and 10.4 g of a 2.5% strength sodium persulfate solution, initial polymization was carried out for 15 minutes. Then the remainder of the preliminary emulsion and also 198.5 g of a 2.5% strength sodium persulfate solution were metered in at 90° C. over the course of 3 h. After the addition of 62 g of water, the reaction mixture was cooled to 85° C., after which 6.0 g of concentrated ammonia were added and subsequent polymerization took place for 30 minutes.

For residual monomer depletion, 41.4 g of a 3% strength tert-butyl hydroperoxide solution and 40.4 g of a 2.5% strength ascorbic acid solution were then added to the reaction mixture over a period of 60 min. After the final addition of 14.0 g of a 5% strength hydrogen peroxide solution and 16.4 g of concentrated ammonia, the dispersion was cooled to about 30° C. and admixed with 83.3 g of a 43% strength ammoniacal solution of a zinc polyacrylate (polyacrylate: Mw 4000-5000, AN 200-300).

Dispersion data: solids content: 49.7%, pH: 9.5, particle size: 162 nm

### Comparative Example 2

### Crosslinker in First Stage

A first preliminary emulsion was prepared from 70.6 g of water, 25.5 g of a 20% strength aqueous solution of a partly neutralized phosphoric monoester of a fatty alcohol ethoxylate (molar mass about 1100 g/mol), 123 g of n-butyl acrylate, 165 g of styrene, 7.5 g of acrylic acid, 9 g of a 50% strength acrylamide solution, and 1.5 g of 1,4-butanediol diacrylate. A second preliminary emulsion was prepared from 70.6 g of water, 25.5 g of the above partly neutralized phosphoric monoester (in 20% form), 123 g of n-butyl acrylate, 165 g of styrene, 7.5 g of acrylic acid and 9 g of a 50% strength acrylamide solution.

The initial charge, consisting of 194 g of water and 9 g of the above partly neutralized phosphoric monoester (in 20% form), in a polymerization vessel which was equipped with an anchor stirrer, reflux condenser, and two feed vessels, was heated under nitrogen to a temperature of 90° C. and, following addition of 50.3 g of the first preliminary emulsion and 6.3 g of a 2.4% strength sodium persulfate solution, initial polymerization was carried out for 15 minutes. Then the remainder of the first preliminary emulsion, over the course of 90 min, and subsequently, the second preliminary emulsion, over the course of a further 90 min, were metered in. In parallel with this, 118.9 g of a 2.4% strength sodium persulfate solution were added at 90° C. over the course of 3 h. After the addition of 37 g of water, the reaction mixture was cooled to 85° C., after which 4.5 g of concentrated ammonia were added and subsequent polymerization took place for 30 minutes.

For residual monomer depletion, 16.2 g of a 4.5% strength tert-butyl hydroperoxide solution and 16.0 g of a 3.8% strength ascorbic acid solution were then added to the reaction mixture over a period of 60 min. After the final addition of 8.4 g of a 5% strength hydrogen peroxide solution and 12.3 g of concentrated ammonia, the dispersion was cooled to about 30° C. and admixed with 50 g of a 43% strength ammoniacal solution of a zinc polyacrylate (polyacrylate: Mw 4000-5000, AN 200-300).

Dispersion data: solids content: 49.4%, pH: 9.7, particle size: 160 nm

### Inventive Example 3

### Crosslinker in Second Stage

A first preliminary emulsion was prepared from 70.6 g of water, 25.5 g of a 20% strength aqueous solution of a partly neutralized phosphoric monoester of a fatty alcohol ethoxylate (molar mass about 1100 g/mol), 123 g of n-butyl acrylate, 165 g of styrene, 7.5 g of acrylic acid and 9 g of a 50% strength acrylamide solution. A second preliminary emulsion was prepared from 70.6 g of water, 25.5 g of the above partly neutralized phosphoric monoester (in 20% form), 123 g of n-butyl acrylate, 165 g of styrene, 7.5 g of acrylic acid, 9 g of a 50% strength acrylamide solution, and 1.5 g of 1,4-butanediol diacrylate.

The initial charge, consisting of 194 g of water and 9 g of the above partly neutralized phosphoric monoester (in 20% form), in a polymerization vessel which was equipped with an anchor stirrer, reflux condenser, and two feed vessels, was heated under nitrogen to a temperature of 90° C. and, following addition of 50.3 g of the first preliminary emulsion and 6.3 g of a 2.4% strength sodium persulfate solution, initial polymerization was carried out for 15 minutes. Then the remainder of the first preliminary emulsion, over the course of 90 min, and subsequently, the second preliminary emulsion, over the course of a further 90 min, were metered in. In parallel with this, 118.9 g of a 2.4% strength sodium persulfate solution were added at 90° C. over the course of 3 h. After the addition of 37 g of water, the reaction mixture was cooled to 85° C., after which 4.5 g of concentrated ammonia were added and subsequent polymerization took place for 30 minutes.

For residual monomer depletion, 16.2 g of a 4.5% strength tert-butyl hydroperoxide solution and 16.0 g of a 3.8% strength ascorbic acid solution were then added to the reaction mixture over a period of 60 min. After the final addition of 8.4 g of a 5% strength hydrogen peroxide solution and 12.3 g of concentrated ammonia, the dispersion was cooled to about 30° C. and admixed with 50 g of a 43% strength ammoniacal solution of a zinc polyacrylate (polyacrylate: Mw 4000-5000, AN 200-300).

Dispersion data: solids content: 49.5%, pH: 9.6, particle size: 163 nm

The polymer dispersions thus synthesized were used to produce a red paint formulation:

416.6 parts by weight of the polymer dispersion under test (in 50% form) were admixed with 1.9 parts by weight of a commercial defoamer for paints (mixture of polysiloxanes and hydrophobic solids in polyglycol; BYK® 022, Byk) and 3.7 parts by weight of surface-active substance (Surfynol® 104 from Air Products, 50% in n-propanol), and then, using a Dispermat a mixture of 7.5 parts by weight of butyl glycol, 7.5 parts by weight of Solvenon®PP and 7.5 parts by weight of benzine 180-210° C. (film-forming assistant) was added. Additionally, with stirring, a mixture consisting of 1.0 part by weight of an anionic dispersant (acidic phosphoric ester of a fatty alcohol alkoxylate; Lutensit® A-EP, BASF AG), 2.6 parts by weight of concentrated ammonia, and 69.3 parts by weight of water was incorporated.

Subsequently 113.3 parts by weight of a hematite pigment (Bayferrox® 130 M, Lanxess), 109.8 parts by weight of an anticorrosion pigment (Heucophos® ZPZ, Heubach), 47.1 parts by weight of magnesium silicate (filler; Talc 20 M 2, Luzenac), and 170.4 parts by weight of a filler based on barium sulfate and zinc sulfide (30% by weight ZnS) (Litopone® L) were added. The mixture as a whole was dispersed for at least 30 minutes with glass beads (ø 3 mm).

Thereafter, with further stirring, an additional 1.9 parts by weight of BYK® 022 and 5.4 parts by weight of a 1:1 mixture of water and a commercial corrosion inhibitor (corrosion inhibitor L 1, Erbslöh) were added and the glass beads were removed by sieving.

Lastly, the batch was admixed with a 1:1 mixture of a commercial, urethane-based thickener (Collacral® PU 85, BASF AG) with butyl glycol (solvent), and the pH of the paint was adjusted to about 9.6 using concentrated ammonia (about 27.2 parts by weight). This gives 1000 parts by weight of an anticorrosion primer with a solids content of about 66% and a pigment/volume concentration (PVC) of 35%.

The early water-spot resistance of these formulations was found to be as follows:

| Example | Early water-spot resistance |
|---|---|
| 1 | m3-4/g2-3 |
| 2 | m2-3/g2-3 |
| 3 | ok |

### Comparative Example 4

### Continuous Crosslinking

A preliminary emulsion was prepared from 123 g of water, 30.2 g of a 31% strength aqueous solution of the sodium salt of a sulfuric monoester of a fatty alcohol ethoxylate (degree of ethoxylation about 30), 18.3 g of a 20% strength aqueous solution of an OH-terminated alkylphenol ethoxylate (degree of ethoxylation about 25), 299 g of n-butyl acrylate, 275 g of styrene, 15 g of acrylic acid, 21 g of a 50% strength acrylamide solution, and 1.2 g of allyl methacrylate.

The initial charge, consisting of 283 g of water and 27 g of a 33% polystyrene seed latex (particle size about 30 nm), in a polymerization vessel equipped with an anchor stirrer, reflux condenser, and two feed vessels, was heated under nitrogen to a temperature of 85° C. and, following addition of 11.5 g of a 2.5% strength sodium persulfate solution, initial polymerization took place for 5 minutes. Then the preliminary emulsion and also 31.7 g of a 2.5% strength sodium persulfate solution were metered in at 85° C. over the course of 3 h, followed by subsequent polymerization for 30 min.

Following the addition of 19 g of water and 6.3 g of concentrated ammonia, residual monomer depletion was effected by adding to the reaction mixture, over a period of 60 min, 10.8 g of a 3.3% strength tert-butyl hydroperoxide solution and 10.2 g of a 2.9% strength ascorbic acid solution. After the final addition of 8.4 g of a 5% strength hydrogen peroxide solution and also 58 g of a 2% strength ammonia solution, the dispersion was cooled to about 30° C. and admixed with 63.6 g of a 35% strength ammoniacal solution of a zinc polyacrylate (polyacrylate: Mw 4000-5000, AN 200-300).

Dispersion data: solids content: 50.6%, pH: 9.7, particle size: 155 nm

### Inventive Example 5

### Crosslinker in First Stage

A first preliminary emulsion was prepared from 49.6 g of water, 12.4 g of a 31% strength aqueous solution of the sodium salt of a sulfuric monoester of a fatty alcohol ethoxylate (degree of ethoxylation about 30), 7.2 g of a 20% strength aqueous solution of an OH-terminated alkylphenol ethoxylate (degree of ethoxylation about 25), 119.8 g of n-butyl acrylate, 109.7 g of styrene, 6.0 g of acrylic acid, 8.4 g of a 50% strength acrylamide solution, and 1.2 g of allyl methacrylate. A second preliminary emulsion was prepared from 74.3 g of water, 18.6 g of a 31% strength aqueous solution of the above sulfuric monoester, 10.8 g of a 20% strength aqueous solution of the above nonionic alkylphenol ethoxylate, 179.6 g of n-butyl acrylate, 164.2 g of styrene, 9.0 g of acrylic acid, and 12.6 g of a 50% strength acrylamide solution.

The initial charge, consisting of 283 g of water and 27 g of a 33% polystyrene seed latex (particle size about 30 nm), in a polymerization vessel equipped with an anchor stirrer, reflux condenser, and two feed vessels, was heated under nitrogen to a temperature of 85° C. and, following addition of 11.5 g of a 2.5% strength sodium persulfate solution, initial polymerization took place for 5 minutes. Then the first preliminary emulsion was metered in over the course of 72 min and, after that, the second preliminary emulsion was metered in over the course of a further 108 min. In parallel with this, 31.7 g of a 2.5% strength sodium persulfate solution were added at 85° C. over the course of 3 h, and then subsequent polymerization took place for 30 min.

Following the addition of 19 g of water and 6.3 g of concentrated ammonia, residual monomer depletion was effected by adding to the reaction mixture, over a period of 60 min, 10.8 g of a 3.3% strength tert-butyl hydroperoxide solution and 10.2 g of a 2.9% strength ascorbic acid solution. After the final addition of 8.4 g of a 5% strength hydrogen peroxide solution and also 58 g of a 2% strength ammonia solution, the dispersion was cooled to about 30° C. and admixed with 63.6 g of a 35% strength ammoniacal solution of a zinc polyacrylate (polyacrylate: Mw 4000-5000, AN 200-300).

Dispersion data: solids content: 50.5%, pH: 9.8, particle size: 155 nm

### Comparative Example 6

### Crosslinker in Second Stage

A first preliminary emulsion was prepared from 74.3 g of water, 18.6 g of a 31% strength aqueous solution of the sodium salt of a sulfuric monoester of a fatty alcohol ethoxylate (degree of ethoxylation about 30), 10.8 g of a 20% strength aqueous solution of an OH-terminated alkylphenol ethoxylate (degree of ethoxylation about 25), 179.6 g of n-butyl acrylate, 164.2 g of styrene, 9.0 g of acrylic acid, and 12.6 g of a 50% strength acrylamide solution. A second preliminary emulsion was prepared from 49.6 g of water, 12.4 g of a 31% strength aqueous solution of the above sulfuric monoester, 7.2 g of a 20% strength aqueous solution of the above nonionic alkylphenol ethoxylate, 119.8 g of n-butyl acrylate, 109.7 g of styrene, 6.0 g of acrylic acid, 8.4 g of a 50% strength acrylamide solution, and 1.2 g of allyl methacrylate.

The initial charge, consisting of 283 g of water and 27 g of a 33% polystyrene seed latex (particle size about 30 nm), in a polymerization vessel equipped with an anchor stirrer, reflux condenser, and two feed vessels, was heated under nitrogen to a temperature of 85° C. and, following addition of 11.5 g of a 2.5% strength sodium persulfate solution, initial polymerization took place for 5 minutes. Then the first preliminary emulsion was metered in over the course of 108 min and, after that, the second preliminary emulsion was metered in over the course of a further 72 min. In parallel with this, 31.7 g of a 2.5% strength sodium persulfate solution were added at 85° C. over the course of 3 h, and then subsequent polymerization took place for 30 min.

Following the addition of 19 g of water and 6.3 g of concentrated ammonia, residual monomer depletion was effected by adding to the reaction mixture, over a period of 60 min, 10.8 g of a 3.3% strength tert-butyl hydroperoxide solution and 10.2 g of a 2.9% strength ascorbic acid solution. After the final addition of 8.4 g of a 5% strength hydrogen peroxide solution and also 58 g of a 2% strength ammonia solution, the dispersion was cooled to about 30° C. and admixed with 63.6 g of a 35% strength ammoniacal solution of a zinc polyacrylate (polyacrylate: Mw 4000-5000, AN 200-300).

Dispersion data: solids content: 49.5%, pH: 9.6, particle size: 151 nm

The polymer dispersions thus synthesized were used to produce a red paint formulation, in accordance with the following formula:

393.4 parts by weight of the polymer dispersion under test (in 50% form) were admixed with 2.2 parts by weight of a commercial defoamer for paints (mixture of polysiloxanes and hydrophobic solids in polyglycol; BYK® 022, Byk), and then, using a Dispermat a mixture consisting of 0.6 part by weight of an anionic dispersant (acidic phosphoric ester of a fatty alcohol alkoxylate; Lutensit® A-EP, BASF AG), 11.0 parts by weight of concentrated ammonia, and 58.6 parts by weight of water was added. Additionally, with stirring, a mixture of 7.2 parts by weight of Solvenon®PP and 7.2 parts by weight of benzine 180-210° C. (film-forming assistant) was incorporated.

Subsequently 85.0 parts by weight of a hematite pigment (Bayferrox® 130 M, Lanxess), 82.1 parts by weight of an anticorrosion pigment (Heucophos® ZPZ, Heubach), 36.0 parts by weight of magnesium silicate (filler; Talc 20 M 2, Luzenac), and 127.8 parts by weight of a filler based on barium sulfate and zinc sulfide (30% by weight ZnS) (Litopone® L) were added. The mixture as a whole was dispersed for at least 30 minutes with glass beads (ø 3 mm).

Thereafter, with further stirring, an additional 166.4 parts by weight of the polymer dispersion under test (in 50% form) together with 1.9 parts by weight of BYK® 022 and 3.7 parts by weight of a 1:1 mixture of water and a commercial corrosion inhibitor (corrosion inhibitor L 1, Erbslöh) were added and the glass beads were removed by sieving.

Lastly, the batch was admixed with a mixture of 3.7 parts by weight of a commercial, urethane-based thickener (Collacral® PU 85, 25% strength in butyl glycol, BASF AG) with 13.2 parts by weight of butyl glycol (solvent), and the pH was adjusted, if necessary, to about 9.5 using concentrated ammonia. This gives 1000 parts by weight of an anticorrosion primer with a solids content of about 61% and a pigment/volume concentration (PVC) of 23%.

The early water-spot resistance of these formulations was found to be as follows:

| Example | Early water-spot resistance |
|---|---|
| 4 | m3-/g2-4 |
| 5 | ok |
| 6 | No adequate film formation within |
| | 2 h, hence no testing possible |

### Comparative Example 7

### Continuous Crosslinking

A preliminary emulsion was prepared from 292 g of water, 40.0 g of a 30% strength aqueous solution of the sodium salt of a sulfuric monoester of a fatty alcohol ethoxylate (degree of ethoxylation about 30), 30.0 g of a 20% strength aqueous solution of an OH-terminated fatty alcohol ethoxylate (degree of ethoxylation about 30), 300 g of n-butyl acrylate, 294 g of styrene, 15 g of acrylic acid, 21 g of a 50% strength acrylamide solution, and 1.2 g of 1,4-butanediol diacrylate.

The initial charge, consisting of 133 g of water and 26 g of a 33% polystyrene seed latex (particle size about 30 nm), in a polymerization vessel equipped with an anchor stirrer, reflux condenser, and two feed vessels, was heated under nitrogen to a temperature of 85° C. and, following addition of 4.8 g of a 6.3% strength sodium persulfate solution, initial polymerization took place for 5 minutes. Then the preliminary emulsion and also 14.3 g of a 6.3% strength sodium persulfate solution were metered in at 85° C. over the course of 3 h, followed by subsequent polymerization for 15 min.

Following the addition of 18 g of water and 5.4 g of concentrated ammonia, residual monomer depletion was effected by adding to the reaction mixture, over a period of 60 min, 7.8 g of a 7.8% strength tert-butyl hydroperoxide solution and 16.7 g of a 2.2% strength ascorbic acid solution. After the final addition of 0.8 g of a 30% strength hydrogen peroxide solution and also 12.4 g of a 15% strength ammonia solution, the dispersion was cooled to about 30° C. and admixed with 63.6 g of a 35% strength ammoniacal solution of a zinc polyacrylate (polyacrylate: Mw 4000-5000, AN 200-300).

Dispersion data: solids content: 49.8%, pH: 9.6, particle size: 149 nm

### Inventive Example 8

### Crosslinker in First Stage

A first preliminary emulsion was prepared from 116 g of water, 16.0 g of a 30% strength aqueous solution of the sodium salt of a sulfuric monoester of a fatty alcohol ethoxylate (degree of ethoxylation about 30), 12.0 g of a 20% strength aqueous solution of an OH-terminated fatty alcohol ethoxylate (degree of ethoxylation about 30), 121 g of n-butyl acrylate, 109 g of styrene, 6.0 g of acrylic acid, 8.4 g of a 50% strength acrylamide solution, and 0.6 g of 1,4-butanediol diacrylate. A second preliminary emulsion was prepared from 175 g of water, 24.0 g of a 30% strength aqueous solution of the above sulfuric monoester, 18.0 g of a 20% strength aqueous solution of the above nonionic fatty alcohol ethoxylate, 180 g of n-butyl acrylate, 164 g of styrene, 9.0 g of acrylic acid, and 12.6 g of a 50% strength acrylamide solution.

The initial charge, consisting of 140 g of water and 26 g of a 33% polystyrene seed latex (particle size about 30 nm), in a polymerization vessel equipped with an anchor stirrer, reflux condenser, and two feed vessels, was heated under nitrogen to a temperature of 85° C. and, following addition of 4.8 g of a 6.3% strength sodium persulfate solution, initial polymerization took place for 5 minutes. Then the first preliminary emulsion was metered in over the course of 72 min and, after that, the second preliminary emulsion was metered in over the course of a further 108 min. In parallel with this, 14.3 g of a 6.3% strength sodium persulfate solution were added at 85° C. over the course of 3 h, and then subsequent polymerization took place for 15 min.

Following the addition of 9 g of water and 5.4 g of concentrated ammonia, residual monomer depletion was effected by adding to the reaction mixture, over a period of 60 min, 7.7 g of a 7.8% strength tert-butyl hydroperoxide solution and 19.6 g of a 1.8% strength ascorbic acid solution. After the final addition of 1.4 g of a 30% strength hydrogen peroxide solution and also 61 g of a 3% strength ammonia solution, the dispersion was cooled to about 30° C. and admixed with 63.6 g of a 35% strength ammoniacal solution of a zinc polyacrylate (polyacrylate: Mw 4000-5000, AN 200-300).

Dispersion data: solids content: 48.9%, pH: 10.4, particle size: 139 nm

### Inventive Example 9

### Crosslinker in Second Stage

A first preliminary emulsion was prepared from 175 g of water, 24.0 g of a 30% strength aqueous solution of the above sulfuric monoester, 18.0 g of a 20% strength aqueous solution of the above nonionic fatty alcohol ethoxylate, 180 g of n-butyl acrylate, 164 g of styrene, 9.0 g of acrylic acid, and 12.6 g of a 50% strength acrylamide solution. A second preliminary emulsion was prepared from 116 g of water, 16.0 g of a 30% strength aqueous solution of the sodium salt of a sulfuric monoester of a fatty alcohol ethoxylate (degree of ethoxylation about 30), 12.0 g of a 20% strength aqueous solution of an OH-terminated fatty alcohol ethoxylate (degree of ethoxylation about 30), 121 g of n-butyl acrylate, 109 g of styrene, 6.0 g of acrylic acid, 8.4 g of a 50% strength acrylamide solution, and 0.6 g of 1,4-butanediol diacrylate.

The initial charge, consisting of 140 g of water and 26 g of a 33% polystyrene seed latex (particle size about 30 nm), in a polymerization vessel equipped with an anchor stirrer, reflux condenser, and two feed vessels, was heated under nitrogen to a temperature of 85° C. and, following addition of 4.8 g of a 6.3% strength sodium persulfate solution, initial polymerization took place for 5 minutes. Then the first preliminary emulsion was metered in over the course of 108 min and, after that, the second preliminary emulsion was metered in over the course of a further 72 min. In parallel with this, 14.3 g of a 6.3% strength sodium persulfate solution were added at 85° C. over the course of 3 h, and then subsequent polymerization took place for 15 min.

Following the addition of 9 g of water and 5.4 g of concentrated ammonia, residual monomer depletion was effected by adding to the reaction mixture, over a period of 60 min, 7.7 g of a 7.8% strength tert-butyl hydroperoxide solution and 19.6 g of a 1.8% strength ascorbic acid solution. After the final addition of 1.4 g of a 30% strength hydrogen peroxide solution and also 61 g of a 3% strength ammonia solution, the dispersion was cooled to about 30° C. and admixed with 63.6 g of a 35% strength ammoniacal solution of a zinc polyacrylate (polyacrylate: Mw 4000-5000, AN 200-300).

Dispersion data: solids content: 47.3%, pH: 10.3, particle size: 135 nm

The polymer dispersions thus synthesized were used to produce a red paint formulation, in accordance with the formula of inventive examples 4 to 6.

The early water-spot resistance of these formulations was found to be as follows:

| Example | Early water-spot resistance |
|---|---|
| 7 | about 40%, m4-5/g2-3 |
| 8 | m4/g2-3 |
| 9 | 5 blisters, g2 |

1. (canceled)

2. A method of improving early water-spot resistance of a coating on a substrate, comprising applying to the substrate a coating composition comprising at least one polymer dispersion and then evaporating the volatiles, wherein the polymer dispersion comprises polymer particles having a crosslinking density that decreases from inside to outside.

3. The method according to claim 2, wherein the regions of different crosslinking density differ at least in terms of their glass transition temperature, the outer region having a lower glass transition temperature than the inside region.

4. The method according to claim 3, wherein the difference in the glass transition temperatures, ΔTg, between the polymers in the inside and outer region is up to 20° C. in accordance with ASTM standard D3418-03.

5. The method according to claim 2, wherein the glass transition temperature Tg, of the polymer of the phase having the lower Tg, is at least 0° C. and up to 70° C. in accordance with ASTM standard D3418-03.

6. The method according to claim 2, wherein the polymer particles have an average diameter of at least 50 nm and up to 500 nm.

7. The method according to claim 2, wherein the outer region makes up the outer 10 to 40 nm of the total diameter of the polymer particles.

8. The method according to claim 2, wherein an inner, more highly crosslinked phase and an outer, low-crosslinker phase in the polymer particle are distributed in a volume ratio of 10:90-70:30.

9. The method according to claim 2, wherein the polymer particles are obtainable by polymerizing at least two compositions of monomers differing in the amount of crosslinking monomer, the amount of crosslinking monomer decreasing in the course of the polymerization.

10. The method according to claim 2, wherein the polymer particles are obtainable by polymerizing at least two compositions of monomers differing in the amount of crosslinking monomer, the amount of crosslinking monomer increasing in the course of the polymerization.

11. The method according to claim 2, wherein the polymer particles are obtainable by polymerizing at least two compositions of monomers differing in the amount of crosslinking monomer, the amount of regulator changing in the course of the polymerization.

12. The method according to claim 2, wherein the polymer particles are synthesized from
a) 60% to 99.99% by weight of at least one principal monomer selected from the group consisting of C₁-C₂₀ alkyl (meth)acrylates, vinyl esters of carboxylic acids comprising up to 20 C atoms, vinylaromatics having up to 20 C atoms, ethylenically unsaturated nitrites having up to 20 C atoms, vinyl halides having up to 10 C atoms, vinyl ethers of alcohols comprising 1 to 10 C atoms, aliphatic hydrocarbons having 2 to 8 C atoms, or mixtures of these monomers,
b) 0% to 40% by weight of further, copolymerizable monomers, and
c) 0.01% to 3% by weight of at least one crosslinker, having at least two free-radically polymerizable double bonds.

13. The method according to claim 12, wherein monomers a) are selected from the group consisting of methyl methacrylate, n-butyl acrylate, n-hexyl acrylate, octyl acrylate, 2-ethylhexyl acrylate, and styrene, and mixtures of these monomers.

14. The method according to claim 12, wherein monomers b) are selected from the group consisting of methacrylic acid, acrylic acid, acrylamide, 2-hydroxyethyl(meth)acrylate, 2-hydroxypropyl(meth)acrylate, 3-hydroxypropyl(meth)acrylate, 4-hydroxybutyl(meth)acrylate, 4-hydroxybutyl vinyl ether, methacrylamide, itaconic acid, 2′-(acetylacetoxy)ethyl methacrylate, and 2′-(2″-oxoimidazolidin-1″-yl)ethyl methacrylate (ureidoethyl methacrylate).

15. A polymer dispersion comprising polymer particles having a crosslinking density that decreases from inside to outside.

16. The polymer dispersion according to claim 15, wherein the regions of different crosslinking density differ at least in terms of their glass transition temperature, the outer region having a lower glass transition temperature than the inside region.

17. The polymer dispersion according to claim 16, wherein the difference in the glass transition temperatures, ΔTg, between the polymers in the inside and outer region is up to 20° C. in accordance with ASTM standard D3418-03.

18. The polymer dispersion according to claim 15, wherein the glass transition temperature Tg, of the polymer of the phase having the lower Tg, is at least 0° C. and up to 70° C. in accordance with ASTM standard D3418-03.

19. The polymer dispersion according to claim 15, wherein the polymer particles have an average diameter of at least 50 nm and up to 500 nm.

20. The polymer dispersion according to claim 15, wherein the outer region makes up the outer 10 to 40 nm of the total diameter of the polymer particles.

21. The polymer dispersion according to claim 15, wherein an inner, more highly crosslinked phase and an outer, low-crosslinker phase in the polymer particle are distributed in a volume ratio of 10:90-70:30.

22. The polymer dispersion according to claim 15, wherein the polymer particles are obtainable by polymerizing at least two compositions of monomers differing in the amount of crosslinking monomer, the amount of crosslinking monomer decreasing in the course of the polymerization.

23. The polymer dispersion according to claim 15, wherein the polymer particles are obtainable by polymerizing at least two compositions of monomers differing in the amount of crosslinking monomer, the amount of crosslinking monomer increasing in the course of the polymerization.

24. The polymer dispersion according to claim 15, wherein the polymer particles are obtainable by polymerizing at least two compositions of monomers differing in the amount of crosslinking monomer, the amount of regulator changing in the course of the polymerization.

25. The polymer dispersion according to claim 15, wherein the polymer particles are synthesized from
a) 60% to 99.99% by weight of at least one principal monomer selected from the group consisting of C₁-C₂₀ alkyl(meth)acrylates, vinyl esters of carboxylic acids comprising up to 20 C atoms, vinylaromatics having up to 20 C atoms, ethylenically unsaturated nitriles having up to 20 C atoms, vinyl halides having up to 10 C atoms, vinyl ethers of alcohols comprising 1 to 10 C atoms, aliphatic hydrocarbons having 2 to 8 C atoms, or mixtures of these monomers,
b) 0% to 40% by weight of further, copolymerizable monomers, and
c) 0.01% to 3% by weight of at least one crosslinker, having at least two free-radically polymerizable double bonds.

26. The polymer dispersion according to claim 25, wherein monomers a) are selected from the group consisting of methyl methacrylate, n-butyl acrylate, n-hexyl acrylate, octyl acrylate, 2-ethylhexyl acrylate, and styrene, and mixtures of these monomers.

27. The polymer dispersion according to claim 25, wherein monomers b) are selected from the group consisting of methacrylic acid, acrylic acid, acrylamide, 2-hydroxyethyl(meth)acrylate, 2-hydroxypropyl(meth)acrylate, 3-hydroxypropyl (meth)acrylate, 4-hydroxybutyl(meth)acrylate, 4-hydroxybutyl vinyl ether, methacrylamide, itaconic acid, 2′-(acetylacetoxy)ethyl methacrylate, and 2′-(2″-oxoimidazolidin-1″-yl)ethyl methacrylate (ureidoethyl methacrylate).

28. The method according to claim 2, wherein the polymer particles are synthesized from
a) 75% to 99.95% by weight of at least one principal monomer selected from the group consisting of C₁-C₂₀ alkyl(meth)acrylates, vinyl esters of carboxylic acids comprising up to 20 C atoms, vinylaromatics having up to 20 C atoms, ethylenically unsaturated nitriles having up to 20 C atoms, vinyl halides having up to 10 C atoms, vinyl ethers of alcohols comprising 1 to 10 C atoms, aliphatic hydrocarbons having 2 to 8 C atoms, or mixtures of these monomers,
b) 0% to 25% by weight of further, copolymerizable monomers, and
c) 0.05% to 1% by weight of at least one crosslinker, having at least two free-radically polymerizable double bonds.

29. The method according to claim 2, wherein the polymer particles are synthesized from
a) 85% to 99.8% by weight of at least one principal monomer selected from the group consisting of C₁-C₂₀ alkyl(meth)acrylates, vinyl esters of carboxylic acids comprising up to 20 C atoms, vinylaromatics having up to 20 C atoms, ethylenically unsaturated nitrites having up to 20 C atoms, vinyl halides having up to 10 C atoms, vinyl ethers of alcohols comprising 1 to 10 C atoms, aliphatic hydrocarbons having 2 to 8 C atoms, or mixtures of these monomers,
b) 0% to 15% by weight of further, copolymerizable monomers, and
c) 0.2% to 0.25% by weight of at least one crosslinker, having at least two free-radically polymerizable double bonds.

30. The polymer dispersion according to claim 15, wherein the polymer particles are synthesized from
a) 75% to 99.95% by weight of at least one principal monomer selected from the group consisting of C₁-C₂₀ alkyl(meth)acrylates, vinyl esters of carboxylic acids comprising up to 20 C atoms, vinylaromatics having up to 20 C atoms, ethylenically unsaturated nitrites having up to 20 C atoms, vinyl halides having up to 10 C atoms, vinyl ethers of alcohols comprising 1 to 10 C atoms, aliphatic hydrocarbons having 2 to 8 C atoms, or mixtures of these monomers,
b) 0% to 25% by weight of further, copolymerizable monomers, and
c) 0.05% to 1% by weight of at least one crosslinker, having at least two free-radically polymerizable double bonds.

31. The polymer dispersion according to claim 15, wherein the polymer particles are synthesized from
a) 85% to 99.8% by weight of at least one principal monomer selected from the group consisting of C₁-C₂₀ alkyl(meth)acrylates, vinyl esters of carboxylic acids comprising up to 20 C atoms, vinylaromatics having up to 20 C atoms, ethylenically unsaturated nitriles having up to 20 C atoms, vinyl halides having up to 10 C atoms, vinyl ethers of alcohols comprising 1 to 10 C atoms, aliphatic hydrocarbons having 2 to 8 C atoms, or mixtures of these monomers,
b) 0% to 15% by weight of further, copolymerizable monomers, and
c) 0.2% to 0.25% by weight of at least one crosslinker, having at least two free-radically polymerizable double bonds.
